(19) United States
(12) Patent Application Publication
(10) Pub. No.: US 2006/0157622 A1
(43) Pub. Date: Jul. 20, 2006

(54) Multi-purpose inflatable kite

(76) Inventors: David Johnston, Old Lyme, CT (US); James Rushton, Killingworth, CT (US)

Correspondence Address: TOPE-MCKAY & ASSOCIATES, 23852 PACIFIC COAST HIGHWAY #311, MALIBU, CA, 90265, US

(21) Appl. No.: 11/039,618

(22) Filed: Jan. 19, 2005

(51) Int. Cl. B64C 31/06

(52) U.S. Cl. 244/154

(57) ABSTRACT

A multi-purpose inflatable kite is presented that can be used as both a water flotation device and as an inflatable flyable kite. The multi-purpose inflatable kite includes a body formed of a gas-impervious material with a gas-tight fillable interior chamber. An openable aperture is connected with the body to enable filling of the interior chamber with a volume of gas. An attachment apparatus is integrally connected with the body, with a detachable wing connected with the attachment apparatus. When the interior chamber is filled with a gas and when the detachable wing is detached, the body can be utilized as a water flotation device. Alternatively, when the detachable wing is attached with the body, the body in conjunction with the detachable wing operates as a flyable kite.

### FIELD OF INVENTION

The present invention relates to an inflatable flying toy, and more particularly, to a multi-purpose kite with an inflatable body and detachably attachable wings.

### BACKGROUND OF INVENTION

The present invention relates to an inflatable flying toy that can be used as both a kite and a flotation device. Conventional kites are typically made of rods and sheeting, such as plastic sheeting. The sheeting is spread between the rods to form a wind catch, allowing the kite to be pulled up into the air and are prevented from flying away using a string or twine. Although functional for flying, the conventional kites are sometimes difficult to disassemble and carry. Additionally, they do not function as flotation devices because they have few if any buoyant properties when placed in water.

Several patents have been issued that disclose inflatable kites that may be disassembled. U.S. Pat. Nos. 3,086,737; 3,093,335; 3,980,260; 4,026,504; 4,533,099; 5,762,293; 6,105,903; and 6,499,695, issued to Hyman, Pohl, Laske, Christoffel, Crosbie, Chen, and Talamo respectively, disclose kites with an inflatable portion that can be quickly disassembled by simply letting air out of the kite. The kite support members are included in the inflatable portion, providing support for the permanently attached kite wings. Additionally, these kites do not allow for easy removal of the kite string from the kite. If any of these kites were used as a flotation device, the wings and kite string would invariably interfere with their use, possibly resulting in a dangerous aquatic situation.

U.S. Pat. Nos. 3,335,985, and 5,816,537, issued to Neal and Pascoe respectively, disclose inflatable kites that may also be used as a flotation devices. These patents disclose the combination of an inflatable body with inflatable support members. Sheets (i.e., wings) are permanently connected between the support members to provide the kite with a lift surface. Accordingly, the wings do not detach from the body. Additionally, should a user decide to use either of these inventions as a flotation device, the kite strings do not easily detach, potentially resulting in tangling of the kite string with the user.

Thus, a continuing need exists for a multi-purpose inflatable flying toy that allows a user to use the toy as a kite or as a flotation device with detached wings.

### SUMMARY OF INVENTION

The present invention relates to a multi-purpose inflatable kite. The multi-purpose inflatable kite comprises a body including a top portion and a bottom portion. An attachment apparatus is integral with the body, and a detachable wing is included for attaching with the attachment apparatus. When the detachable wing is detached, the body can be utilized as a water flotation device. Alternatively, when the detachable wing is attached with the body, the body in conjunction with the detachable wing operates as a flyable kite. The body is formed of a gas-impervious material having a gas-tight fillable interior chamber. Additionally, an openable aperture is connected with the body to enable filling of the interior chamber with a volume of gas.

In another aspect, the attachment apparatus is attached with the top portion of the body.

Furthermore, the detachable wing includes two halves, each half including two elongated rods with a connector. The elongated rods are connectable through the connector so that the two halves may be connected to form a detachable wing. A protector is included to cover the connector such that the connector is shielded from contact with the body. A sheet spans between the two elongated rods of each half of the detachable wing, functioning as a wind catch to provide lift for the multi-purpose inflatable kite.

In yet another aspect, the attachment apparatus is a mechanism selected from a group consisting of a clip, a hook, and a loop formation, thereby allowing for connection with an elongated rod.

Furthermore, each elongated rod further includes a clip for attaching with the loop formation, allowing the clip of the elongated rod to be slid through the loop formation and thereby connecting the detachable wing with the body.

The present invention further comprises a kite string connector attached with the body to allow for attachment/detachment of a kite string. Additionally, a kite string with a kite string clip is included for attaching with the kite string connector, whereby a user may quickly attach the kite string with the body to form an inflatable flying kite.

In another aspect, a tail attachment is connected with the body. The tail attachment is selected from a group consisting of a streamer and a spinner.

Furthermore, the body is formed in a shape to represent an object selected from a group consisting of an airplane, a marine animal, a super hero, an automobile, a dinosaur, a bird, a ship, and a geometric shape.

The present invention further comprises a second attachment apparatus is attached with the bottom portion of the body.

In another aspect, a second detachable wing is included for attaching with the second attachment apparatus.

In yet another aspect, the detachable wing is connected with the body such that one elongated rod is connected with an attachment apparatus on the top portion, while another elongated rod is connected with the second attachment apparatus on the bottom portion of the body, where when connected, the sheet bisects the body from the top portion to the bottom portion.

In another aspect, the detachable wing is formed of a gas-impervious material, formed such that it has a gas-tight fillable interior chamber, whereby when inflated, each detachable wing functions as both a flotation device and as a wind catch to provide lift for the multi-purpose inflatable kite.

In yet another aspect, the body is formed of a water buoyant material, such that it functions both as a kite body and a water flotation device. The water buoyant material is selected from a group consisting of foam and Styrofoam.

In another aspect, the attachment apparatus is a hole formed through the body, with the hole formed to accommodate the detachable wing such that a detachable wing passed through the hole is thereby affixed with the body.

Finally, as can be appreciated by one the art, the present invention also comprises a method for forming the multi-purpose inflatable kite described herein.

### BRIEF DESCRIPTION OF THE DRAWINGS

The objects, features and advantages of the present invention will be apparent from the following detailed descriptions of the various aspects of the invention in conjunction with reference to the following drawings, where:

FIG. 1 is a top-view illustration of a multi-purpose inflatable kite according to the present invention;

FIG. 2 is an illustration of an openable aperture according to the present invention;

FIG. 3 is an illustration of a detachable wing according to the present invention;

FIG. 4 is an illustration of the detachable wing being connected with an attachment apparatus according to the present invention;

FIG. 5 is a bottom-view illustration of a multi-purpose inflatable kite according to the present invention;

FIG. 6 is a top-view illustration of a multi-purpose inflatable kite, with inflatable detachable wings according to the present invention;

FIG. 7 is a top-view illustration of another aspect of a multi-purpose inflatable kite according to the present invention; and

FIG. 8 is a top-view illustration of another aspect of a multi-purpose inflatable kite according to the present invention, where the body is formed with a hole passing there through, such that the detachable wing can be passed through the hole.

### DETAILED DESCRIPTION

The present invention relates to an inflatable flying toy, and more particularly to a multi-purpose kite with an inflatable body and detachably attachable wings. The following description is presented to enable one of ordinary skill in the art to make and use the invention and to incorporate it in the context of particular applications. Various modifications, as well as a variety of uses in different applications will be readily apparent to those skilled in the art, and the general principles defined herein may be applied to a wide range of embodiments. Thus, the present invention is not intended to be limited to the embodiments presented, but is to be accorded the widest scope consistent with the principles and novel features disclosed herein.

In the following detailed description, numerous specific details are set forth in order to provide a more thorough understanding of the present invention. However, it will be apparent to one skilled in the art that the present invention may be practiced without necessarily being limited to these specific details.

The reader's attention is directed to all papers and documents which are filed concurrently with this specification and which are open to public inspection with this specification, and the contents of all such papers and documents are incorporated herein by reference. All the features disclosed in this specification, (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Furthermore, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of” or “act of” in the claims herein is not intended to invoke the provisions of 35 U.S.C. 112, Paragraph 6.

Before describing the invention in detail, an introduction is provided to provide the reader with a general understanding of the present invention. Second, a detailed description of various aspects of the present invention is provided to give an understanding of the specific details.

(1) Introduction

The present invention relates to a multi-purpose inflatable flying toy that functions both as a kite and as an inflatable device. Although inflatable kites have been previously devised, the prior art has several drawbacks. The inflatable kites of the prior art include wings that are non-detachable. Additionally, the prior art does not allow for easy detachment of the kite string. Use of kites of the prior art as a flotation device may result in a potentially dangerous situation, where both the attached wings and kite string may interfere with and become dangerously entangled with a user.

The present invention overcomes problems associated with the prior art by presenting an inflatable body with detachable wings. Additionally, the kite string is attached with the inflatable body through a clip that allows the string to be easily detached. When the detachable wings and kite string are attached with the inflatable body, together they form an inflatable flying kite. Alternatively, when both the wings and kite string are detached from the inflatable body, a user may easily use the inflatable body as a flotation device

(2) Description

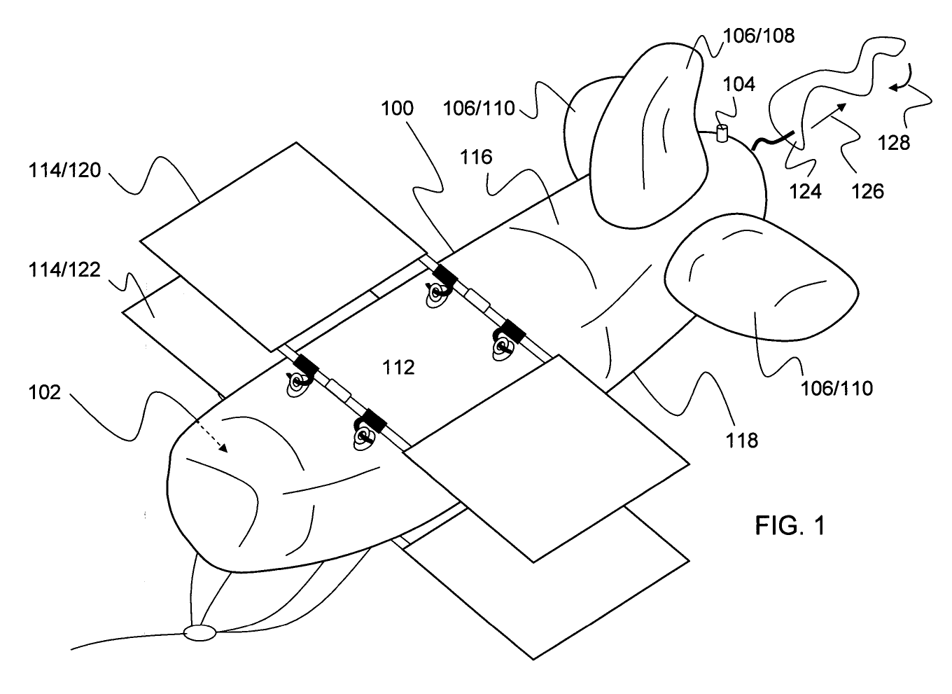

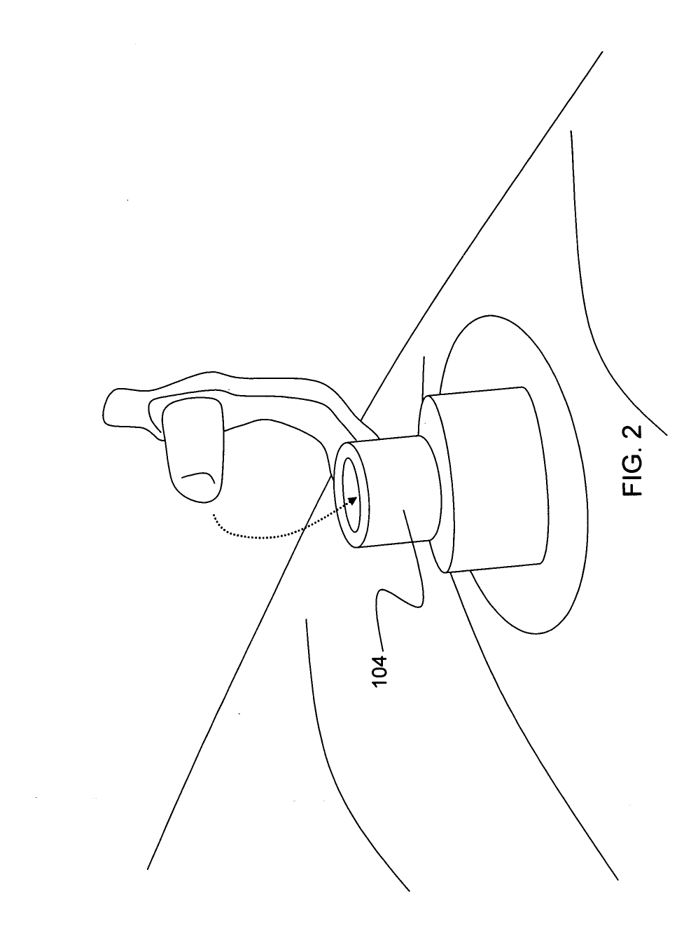

In one aspect, and as shown in FIG. 1, the present invention comprises a body 100 formed of a gas-impervious material. The material is a suitable light-weight, gas-impervious material, non-limiting examples of which include plastic, and foil. The body 100 is formed such that it has a gas-tight fillable interior chamber 102. As can be appreciated by one in the art, there are numerous techniques to form the body 100 such that it includes a gas-tight fillable interior chamber 102. For example, the body 100 may comprise a plurality of plastic sheets (or Mylar) fused together. An openable aperture 104 is connected with the body 100 such that when opened, a user may fill the interior chamber 102 with a volume of gas through the openable aperture 104. As shown in FIG. 2, the openable aperture 104 is a device or mechanism that allows it to be selectively opened and closed, non-limiting example of which includes a flip-top device such as those customarily included in pool flotation devices, and pin-type receptacles like those customarily included in basketballs.

In another aspect, the body 100 could be formed of a lightweight water buoyant material, a non-limiting example of which includes a foam or Styrofoam.

Additionally, and as shown in FIG. 1, the body 100 may be formed in a variety of shapes to represent a variety of objects, non-limiting examples of which include an airplane, a super hero, a marine animal, an automobile, a dinosaur, a bird, a ship, and a geometric shape. Appendages 106 may be attached with the body 100 to further represent the object. For example, when an airplane, the body 100 is formed to represent the fuselage and cabin, with appendages 106 formed in a shape to represent the plane's tail fin 108 and rear wings 110. As another non-limiting example, the body 100 may be formed in the shape of a marine animal such as a dolphin or fish, with the appendages 106 formed to represent the marine animal's fin.

The appendages 106 may simply be solid objects attached with an exterior portion of the body 100, or they may be inflatable appendages 106. When inflatable, the appendages 106 may include their own gas-tight fillable interior chamber or, alternatively, may be connected with the body 100 such that they share the body's interior chamber 102.

At least one attachment apparatus 112 is integrally formed with the body 100 for attaching a detachable wing 114 proximate the body 100. The attachment apparatus 112 is a mechanism or device suitable for easily attaching/detaching the detachable wing 114, non-limiting examples of which include a clip, a hook, and a loop formation. In another aspect, the attachment apparatus 112 can be a hole formed through the body 100 where the detachable wing 114 is passed through the hole, thereby affixing it with the body 100.

In some aspects, it may be desirable to include a plurality of attachment apparati 112 for attaching with a plurality of detachable wings 114. For example, a bi-plane includes two sets of wings. In such an aspect, the body 100 includes a top portion 116 and a bottom portion 118, with a first detachable wing 120 attached with an attachment apparatus 112 on the top portion 116, and a second detachable wing 122 attached with a second attachment apparatus 112 on the bottom portion 118. Alternatively, a plurality of detachable wings 114 may be in included to represent different objects. For example, the detachable wings 114 may be interchangeable to make different types of planes, sea creatures, etc.

For additional decorative properties, a tail attachment 124 can be attached with the body 100. The tail attachment 124 is selected from a variety of decorative tail devices, non-limiting examples of which include streamers and spinners. For example, the spinner is formed in such a way that as air 126 passes by it, the spinner rotates 128 and thereby spins.

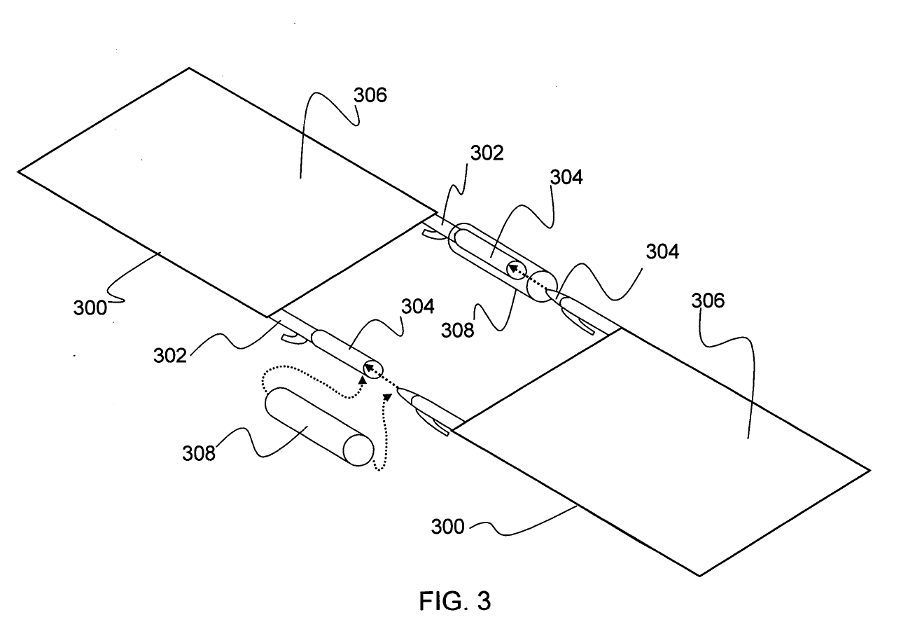

As can be appreciated by one in the art, the detachable wings 114 can be formed in a variety of manners to provide lift, yet allow them to be detachable. In one example and as shown in FIG. 3, each detachable wing 114 includes two halves 300. Each half 300 includes two elongated rods 302 with a connector 304 (e.g., ferrule with male and female ends), where the two halves 300 are connectable through the connector 304 to form the detachable wing 114. A sheet 306 is attached with each of the elongated rods 302 so that it spans a gap between the two elongated rods 302. The sheet 306 is formed of a material that is sufficiently non-porous to function as a wind catch and provide lift for the inflatable kite, non-limiting examples of which include nylon, plastic, and aluminum foil. Additionally, a protector 308 can be included to cover the connector 304. The protector 308 can be any lightweight covering suitable for shielding the inflatable body from sharp edges of the connector 304, a non-limiting example of which includes plastic tubing. In such an aspect, the protector 308 is slid over the connector 304 such that the two halves 300 are connected inside the protector 308, thereby preventing the connector 304 from directly contacting the body.

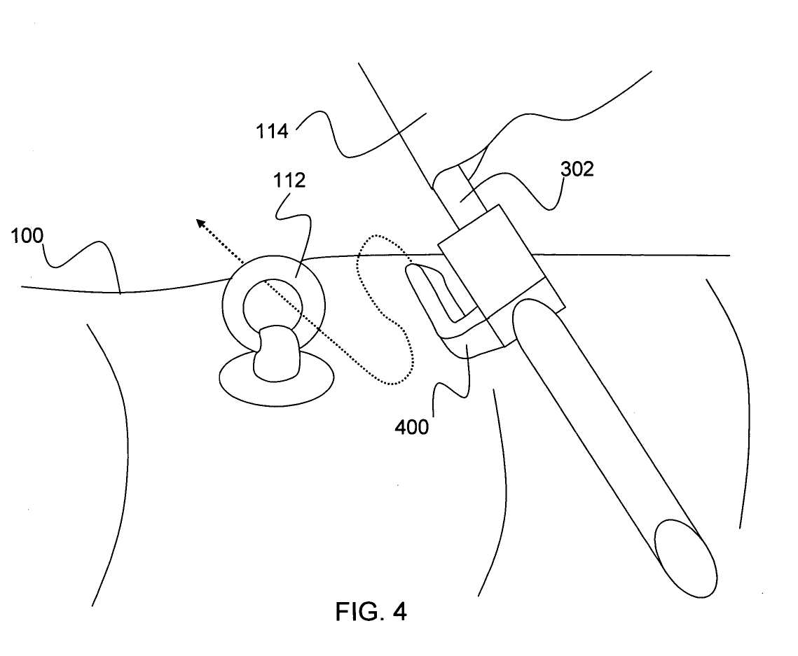

FIG. 4 illustrates a detachable wing 114 being connected with the attachment apparatus 112 and therefore with the body 100. Both the detachable wing 114 and the attachment apparatus 112 can be formed in a variety of ways to allow easy attachment/detachment of the detachable wings 114. For example, each elongated rod 302 includes a wing connector 400 for attaching with the attachment apparatus 112; a non-limiting example of such a wing connector 400 includes a clip. The attachment apparatus 112 is formed such that it is connectable with the wing connector 400, a non-limiting example of which includes a loop.

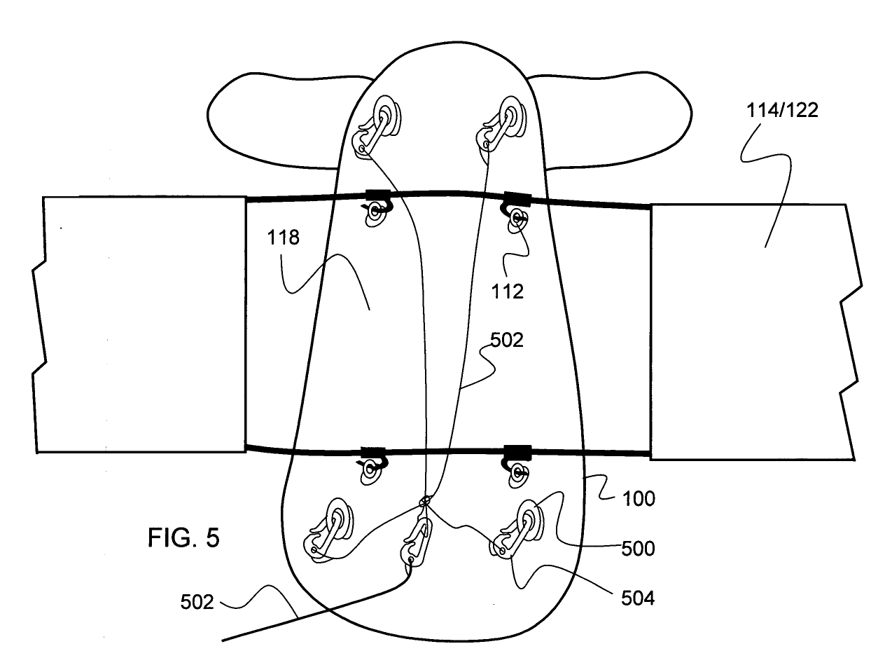

FIG. 5 illustrates a bottom portion 118 of the body 100. As shown in FIG. 5, the second detachable wing 122 is attached with the second attachment apparatus 112 on the bottom portion 118. Additionally, kite string connectors 500 are attached with the body 100 to allow for easy attachment/detachment of a kite string 502. The kite string 502 is attached with the kite string connectors 500 using a kite string clip 504. Through the kite string clip 504, a user may quickly attach the kite string 502 with the body 100 to form an inflatable flying kite, or alternatively, once the detachable wings 114 are detached, a user may easily detach the kite string 502 from the body to leave a flotation device.

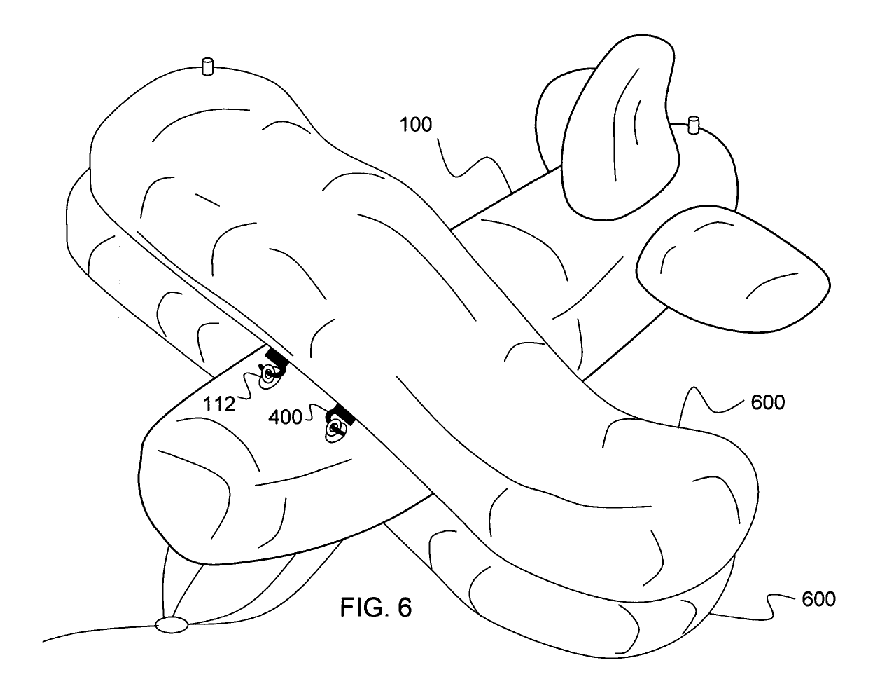

In another aspect, the detachable wing is also inflatable. As shown in FIG. 6, an inflatable detachable wing 600 is formed of a gas-impervious material such that it has a gas-tight fillable interior chamber. When inflated, each inflatable detachable wing 600 functions as both a flotation device and as a wind catch to provide lift for the multi-purpose inflatable kite. The inflatable detachable wing 600 connects with the body 100 in the same manner as the detachable wing 114 of FIG. 1, using a wing connector 400 and an attachment apparatus 112. As another non-limiting example, the detachable wing 600 could be formed of a lightweight water buoyant material, a non-limiting example of which includes foam or Styrofoam.

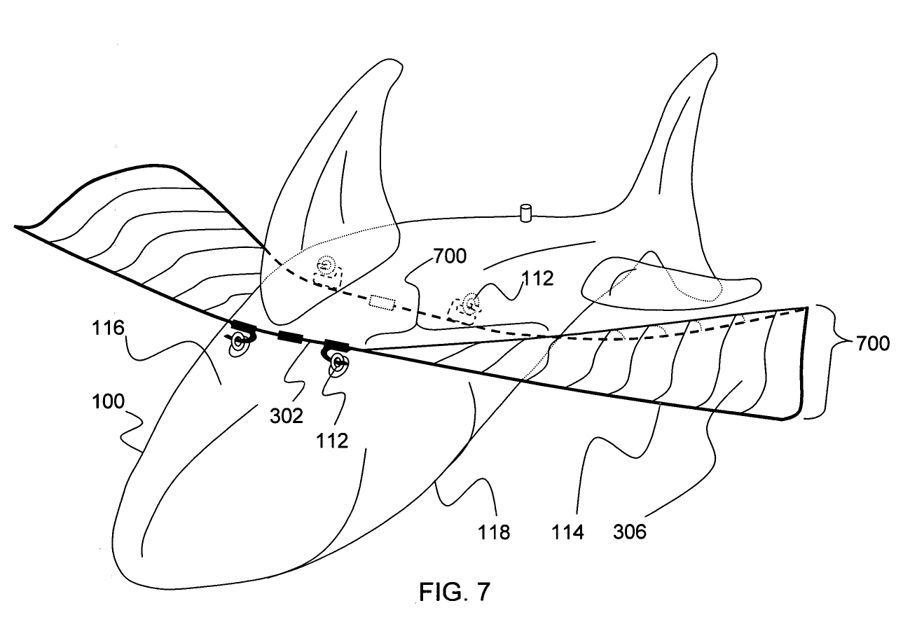

FIG. 7 illustrates another aspect of the present invention. As discussed previously, the body 100 can be formed in a variety of shapes to represent a variety of objects. For example and as shown in FIG. 7, the body 100 can be formed in a shape to represent an aquatic animal such as a whale or fish. Also, the detachable wing 114 can be connected with the body 100 such that one elongated rod 302 is connected with an attachment apparatus 112 on the top portion 116, while another elongated rod 302 is attached with an attachment apparatus 112 on the bottom portion 118, and when connected, the sheet 306 bisects the body 100 from the top portion 116 to the bottom portion 118. An effect of such a configuration is that a width 700 of the detachable wing 114 runs diagonally from the top portion 116 to the bottom portion 118 of the body 100, thereby providing additional support for the detachable wing 114. Furthermore, as can be appreciated by one in the art, the attachment apparatus 112 can be connected with the body 100 in a variety of locations to allow for various configurations of the detachable wing 114.

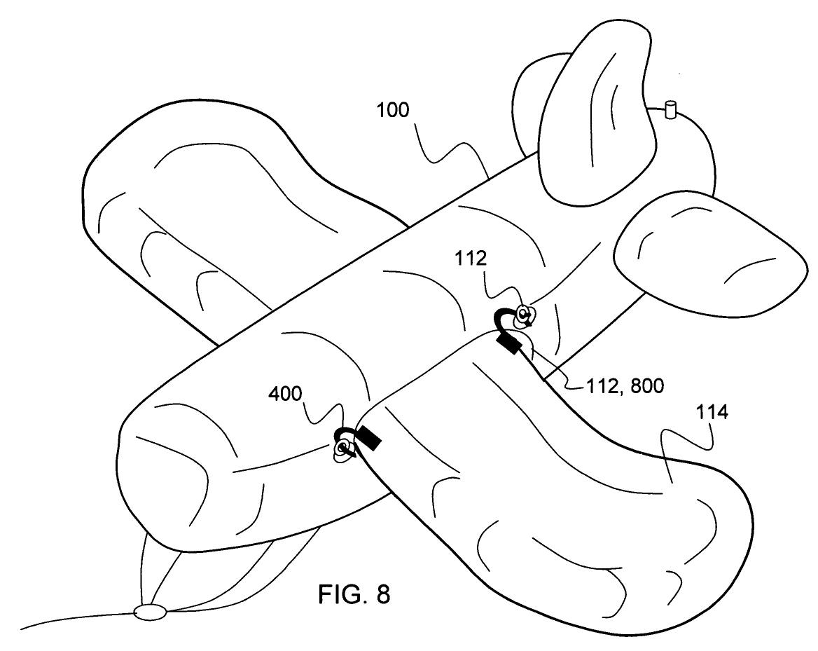

FIG. 8 illustrates another aspect according to the present invention, where the body 100 is formed with a hole 800 there through. In this aspect, the detachable wing 114 is passed through the hole, thereby affixing it with the body 100. Because the hole 800 is integrally formed with the body 100 and aids in affixing the detachable wing 114 with the body 100, the hole 800 functions as the attachment apparatus 112. Additionally, other forms of attachment apparatus 112 (as previously described) can be connected with the body 100 to be affixed with wing connectors 400, thereby further connecting the detachable wing 114 with the body 100. Furthermore, both the detachable wing 114 and body 100 can be inflatable as described above, or formed of any other suitable materials described herein.

What is claimed is:

1. A multi-purpose inflatable kite, comprising:
a body including a top portion and a bottom portion;
an attachment apparatus integral with the body; and
a detachable wing for attaching with the attachment apparatus, whereby when the detachable wing is detached, the body can be utilized as a water flotation device, and when the detachable wing is attached with the body, the body in conjunction with the detachable wing operates as a flyable kite.

2. A multi-purpose inflatable kite as set forth in claim 1, wherein the body is formed of a gas-impervious material, the body having a gas-tight fillable interior chamber, whereby when the interior chamber of the body is filled with a gas and when the detachable wing is detached, the body can be utilized as a water flotation device, and when the detachable wing is attached with the body, the body in conjunction with the detachable wing operates as a flyable kite.

3. A multi-purpose inflatable kite as set forth in claim 2, further comprising an openable aperture connected with the body to enable filling of the interior chamber with a volume of gas.

4. A multi-purpose inflatable kite as set forth in claim 3, wherein the attachment apparatus is attached with the top portion of the body.

5. A multi-purpose inflatable kite as set forth in claim 4, wherein the detachable wing includes two halves, each half including two elongated rods with a connector, where the elongated rods are connectable through the connector so that the two halves may be connected to form a detachable wing.

6. A multi-purpose inflatable kite as set forth in claim 5, further comprising a protector to cover the connector such that the connector is shielded from contact with the body.

7. A multi-purpose inflatable kite as set forth in claim 6, further comprising a sheet spanning between the two elongated rods of each half of the detachable wing, the sheet functioning as a wind catch to provide lift for the multi-purpose inflatable kite.

8. A multi-purpose inflatable kite as set forth in claim 7, wherein the attachment apparatus is a mechanism selected from a group consisting of a clip, a hook, and a loop formation, thereby allowing for connection with an elongated rod.

9. A multi-purpose inflatable kite as set forth in claim 8, wherein each elongated rod further includes a clip for attaching with the loop formation, allowing the clip of the elongated rod to be slid through the loop formation and thereby connecting the detachable wing with the body.

10. A multi-purpose inflatable kite as set forth in claim 9, further comprising a kite string connector attached with the body to allow for attachment/detachment of a kite string.

11. A multi-purpose inflatable kite as set forth in claim 10, further comprising a kite string with a kite string clip for attaching with the kite string connector, whereby a user may quickly attach the kite string with the body to form an inflatable flying kite.

12. A multi-purpose inflatable kite as set forth in claim 11, further comprising a tail attachment connected with the body.

13. A multi-purpose inflatable kite as set forth in claim 12, wherein the tail attachment is selected from a group consisting of a streamer and a spinner.

14. A multi-purpose inflatable kite as set forth in claim 13, wherein the body is formed in a shape to represent an object selected from a group consisting of an airplane, a marine animal, a super hero, an automobile, a dinosaur, a bird, a ship, and a geometric shape.

15. A multi-purpose inflatable kite as set forth in claim 14, further comprising a second attachment apparatus attached with the bottom portion of the body.

16. A multi-purpose inflatable kite as set forth in claim 15, further comprising a second detachable wing for attaching with the second attachment apparatus.

17. A multi-purpose inflatable kite as set forth in claim 15, wherein the detachable wing is connected with the body such that one elongated rod is connected with an attachment apparatus on the top portion, while another elongated rod is connected with the second attachment apparatus on the bottom portion of the body, where when connected, the sheet bisects the body from the top portion to the bottom portion.

18. A multi-purpose inflatable kite as set forth in claim 2, wherein the detachable wing is formed of a gas-impervious material, formed such that it has a gas-tight fillable interior chamber, whereby when inflated, each detachable wing functions as both a flotation device and as a wind catch to provide lift for the multi-purpose inflatable kite.

19. A multi-purpose inflatable kite as set forth in claim 1, wherein the detachable wing is formed of a gas-impervious material, formed such that it has a gas-tight fillable interior chamber, whereby when inflated, each detachable wing functions as both a flotation device and as a wind catch to provide lift for the multi-purpose inflatable kite.

20. A multi-purpose inflatable kite as set forth in claim 1, wherein the body is formed of a water buoyant material, such that it functions both as a kite body and a water flotation device.

21. A multi-purpose inflatable kite as set forth in claim 20, wherein the water buoyant material is selected from a group consisting of foam and Styrofoam.

22. A multi-purpose inflatable kite as set forth in claim 21, wherein the detachable wing is formed of a gas-impervious material, formed such that it has a gas-tight fillable interior chamber, whereby when inflated, each detachable wing functions as both a flotation device and as a wind catch to provide lift for the multi-purpose inflatable kite.

23. A multi-purpose inflatable kite as set forth in claim 1, wherein the attachment apparatus is a hole formed through the body, the hole formed to accommodate the detachable wing, such that a detachable wing passed through the hole is thereby affixed with the body.

24. A multi-purpose inflatable kite as set forth in claim 23, wherein the detachable wing is formed of a gas-impervious material, formed such that it has a gas-tight fillable interior chamber, whereby when inflated, each detachable wing functions as both a flotation device and as a wind catch to provide lift for the multi-purpose inflatable kite.

25. A multi-purpose inflatable kite as set forth in claim 23, wherein the body is formed of a gas-impervious material, the body having a gas-tight fillable interior chamber, whereby when the interior chamber of the body is filled with a gas and when the detachable wing is detached, the body can be utilized as a water flotation device, and when the detachable wing is attached with the body, the body in conjunction with the detachable wing operates as a flyable kite.

26. A multi-purpose inflatable kite as set forth in claim 1, wherein the attachment apparatus is attached with the top portion of the body.

27. A multi-purpose inflatable kite as set forth in claim 1, wherein the detachable wing includes two halves, each half including two elongated rods with a connector, where the elongated rods are connectable through the connector so that the two halves may be connected to form a detachable wing.

28. A multi-purpose inflatable kite as set forth in claim 27, further comprising a protector to cover the connector such that the connector is shielded from contact with the body.

29. A multi-purpose inflatable kite as set forth in claim 27, further comprising a sheet spanning between the two elongated rods of each half of the detachable wing, the sheet functioning as a wind catch to provide lift for the multi-purpose inflatable kite.

30. A multi-purpose inflatable kite as set forth in claim 27, wherein the attachment apparatus is a mechanism selected from a group consisting of a clip, a hook, and a loop formation, thereby allowing for connection with an elongated rod.

31. A multi-purpose inflatable kite as set forth in claim 30, wherein each elongated rod further includes a clip for attaching with the loop formation, allowing the clip of the elongated rod to be slid through the loop formation and thereby connecting the detachable wing with the body.

32. A multi-purpose inflatable kite as set forth in claim 1, further comprising a kite string connector attached with the body to allow for attachment/detachment of a kite string.

33. A multi-purpose inflatable kite as set forth in claim 32, further comprising a kite string with a kite string clip for attaching with the kite string connector, whereby a user may quickly attach the kite string with the body to form an inflatable flying kite.

34. A multi-purpose inflatable kite as set forth in claim 1, further comprising a tail attachment connected with the body.

35. A multi-purpose inflatable kite as set forth in claim 34, wherein the tail attachment is selected from a group consisting of a streamer and a spinner.

36. A multi-purpose inflatable kite as set forth in claim 1, wherein the body is formed in a shape to represent an object selected from a group consisting of an airplane, a marine animal, a super hero, an automobile, a dinosaur, a bird, a ship, and a geometric shape.

37. A multi-purpose inflatable kite as set forth in claim 1, further comprising a second attachment apparatus attached with the bottom portion of the body.

38. A multi-purpose inflatable kite as set forth in claim 37, further comprising a second detachable wing for attaching with the second attachment apparatus.

39. A multi-purpose inflatable kite as set forth in claim 37, wherein the detachable wing is connected with the body such that one elongated rod is connected with an attachment apparatus on the top portion, while another elongated rod is connected with the second attachment apparatus on the bottom portion of the body, where when connected, the sheet bisects the body from the top portion to the bottom portion.

40. A method for forming a multi-purpose inflatable kite, comprising:
forming a body having a top portion and a bottom portion;
forming an attachment apparatus integral with the body; and
forming a detachable wing for attaching with the attachment apparatus, whereby when the detachable wing is detached, the body can be utilized as a water flotation device, and when the detachable wing is attached with the body, the body in conjunction with the detachable wing operates as a flyable kite.

41. A method for forming a multi-purpose inflatable kite as set forth in claim 40, wherein in the act of forming the body, the body is formed of a gas-impervious material having a gas-tight fillable interior chamber, whereby when the interior chamber of the body is filled with a gas and when the detachable wing is detached, the body can be utilized as a water flotation device, and when the detachable wing is attached with the body, the body in conjunction with the detachable wing operates as a flyable kite.

42. A multi-purpose inflatable kite, comprising:
a body including a top portion and a bottom portion;
an attachment apparatus integral with the body;
a detachable wing for attaching with the attachment apparatus;
wherein the body is formed of a gas-impervious material, the body having a gas-tight fillable interior chamber;
an openable aperture connected with the body to enable filling of the interior chamber with a volume of gas;
wherein the attachment apparatus is attached with the top portion of the body;
wherein the detachable wing includes two halves, each half including two elongated rods with a connector, where the elongated rods are connectable through the connector so that the two halves may be connected to form a detachable wing;
a protector covering the connector such that the connector is shielded from contact with the body;
sheet spanning between the two elongated rods of each half of the detachable wing, the sheet functioning as a wind catch to provide lift for the multi-purpose inflatable kite;
wherein the attachment apparatus is a loop formation, thereby allowing for connection with an elongated rod;
wherein each elongated rod further includes a clip for attaching with the loop formation, allowing the clip of the elongated rod to be slid through the loop formation and thereby connecting the detachable wing with the body;
a kite string connector attached with the body to allow for attachment/detachment of a kite string;
a kite string with a kite string clip for attaching with the kite string connector, whereby a user may quickly attach the kite string with the body to form an inflatable flying kite;
a tail attachment connected with the body; and
wherein the body is formed in a shape to represent an object selected from a group consisting of an airplane, a marine animal, a super hero, an automobile, a dinosaur, a bird, a ship, and a geometric shape.
